(19) United States
(12) Patent Application Publication
(10) Pub. No.: US 2026/0044619 A1
(43) Pub. Date: Feb. 12, 2026

(54) SYSTEMS AND METHODS FOR CREATING AND IMPLEMENTING ETHICAL SCREENS ACROSS DIFFERENT SOFTWARE PLATFORMS

(71) Applicants: Ahmed Farouk SHAABAN, South Barrington, IL (US); Venkat THANDRA, South Barrington, IL (US)

(72) Inventors: Ahmed Farouk SHAABAN, South Barrington, IL (US); Venkat THANDRA, South Barrington, IL (US)

(21) Appl. No.: 19/294,112

(22) Filed: Aug. 7, 2025

Related U.S. Application Data
(60) Provisional application No. 63/681,735, filed on Aug. 9, 2024.

(51) Int. Cl. G06F 21/62

(52) U.S. Cl. CPC G06F 21/6218

(57) ABSTRACT

Systems and methods for creating and implementing ethical screens across different software platforms are disclosed herein. In an embodiment, a method for implementing an ethical screen across a plurality of different software platforms includes receiving ethical screen inputs regarding a conflict between a first client and a second client, generating ethical screen parameters based on the ethical screen inputs, accessing at least one reference table to determine a plurality of users corresponding to the ethical screen parameters, and implementing the ethical screen across the plurality of different platforms using a plurality of user identifications or passwords corresponding to the plurality of users.

### RELATED APPLICATION

This application claims priority to U.S. Provisional Application No. 63/681,735, filed Aug. 9, 2024 and entitled “Systems and Methods for Creating and Implementing Ethical Screens Across Different Software Platforms,” the entire contents of which is incorporated herein by reference and relied upon.

### BACKGROUND

### Technical Field

This disclosure generally relates to systems and methods for creating and implementing ethical screens across different software platforms. More specifically, this disclosure generally relates to systems and methods that implement ethical screens across different platforms without the user having to navigate into the different platforms, open applications, and input or revise various individual screening or security parameters.

### Background Information

Many businesses such as law firms, accounting firms and consulting firms represent a wide variety of clients. These clients can sometimes be competitors of each other, which raises conflict of interest issues if the same firm represents both parties. The firm may therefore need to put an ethical screen in place to ensure that employees performing work for one client do not access information about a competitor client, and vice versa. In theory, the employees working for one client can agree not to access materials of the other competitor client. In practice, however, it is difficult to prevent employees from unintentionally accessing the files of competitor clients, particularly when the firm uses multiple software platforms and shares or reuses templates or research prepared for previous clients.

### SUMMARY

The present disclosure provides improved systems and methods for creating and implementing ethical screens across different software platforms. The disclosed systems and methods are advantageous, for example, because they enable employees of a firm to create and implement ethical screens across different software platforms without having to navigate into the different platforms, open applications, and input or revise various screening or security parameters.

A first aspect of the present disclosure is to provide a method for implementing an ethical screen across a plurality of different software platforms. The method includes receiving ethical screen inputs regarding a conflict between a first client and a second client, generating ethical screen parameters based on the ethical screen inputs, accessing at least one application table to determine a plurality of users corresponding to the ethical screen parameters, and implementing the ethical screen across the plurality of different software platforms using a plurality of user identifications or passwords corresponding to the plurality of users.

A second aspect of the present disclosure is to provide another method for implementing an ethical screen across a plurality of different software platforms. The method includes receiving ethical screen inputs regarding a conflict between a first client and a second client, generating ethical screen parameters applied to a plurality of matters for the first client, accessing an application table to determine a plurality of users corresponding to the plurality of matters, and applying the ethical screen across the plurality of different software platforms using a plurality of user identifications or passwords corresponding to the plurality of users as defined by the application table.

A third aspect of the present disclosure is to provide a system for implementing an ethical screen across a plurality of different software platforms. The system includes a first software platform, a second software platform, at least one application table and a central server. The first software platform is utilized by a first user and a second user of a first party to perform a first task for a plurality of clients. The second software platform is utilized by the first user and the second user of the first party to perform a second task for the plurality of clients. The application table corresponds ethical screen parameters to the first user and the second user of the first party. The central server includes a processor and a memory. The processor is configured to implement instructions stored on the memory to (i) generate an ethical screen that prohibits the first user from working for a second client of the plurality of clients and prevents the second user from working for a first client of the plurality of clients, (ii) use the at least one application table to encode the first software platform and the second software platform to implement a first screen preventing the first user from accessing work performed for the second client, and (iii) use the at least one application table to encode the first software platform and the second software platform to implement a second screen preventing the second user from accessing work performed for the first client.

Other objects, features, aspects and advantages of the systems and methods disclosed herein will become apparent to those skilled in the art from the following detailed description, which, taken in conjunction with the annexed drawings, discloses exemplary embodiments of the disclosed systems and methods.

### BRIEF DESCRIPTION OF THE DRAWINGS

Referring now to the attached drawings which form a part of this original disclosure:

FIG. 1 illustrates an example embodiment of a system for generating and implementing ethical screens in accordance with the present disclosure;

FIG. 2 illustrates an example embodiment of a user terminal which can be used in the system of FIG. 1;

FIG. 3 illustrates an example embodiment of a method of creating and implementing an ethical screen in accordance with the present disclosure;

FIGS. 4 to 8 illustrate an example embodiment of a graphical user interface configured to enable a user to generate an ethical screen in accordance with the present disclosure; and

FIGS. 9 and 10 illustrate example embodiments of application tables used to implement an ethical screen in accordance with the present disclosure.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

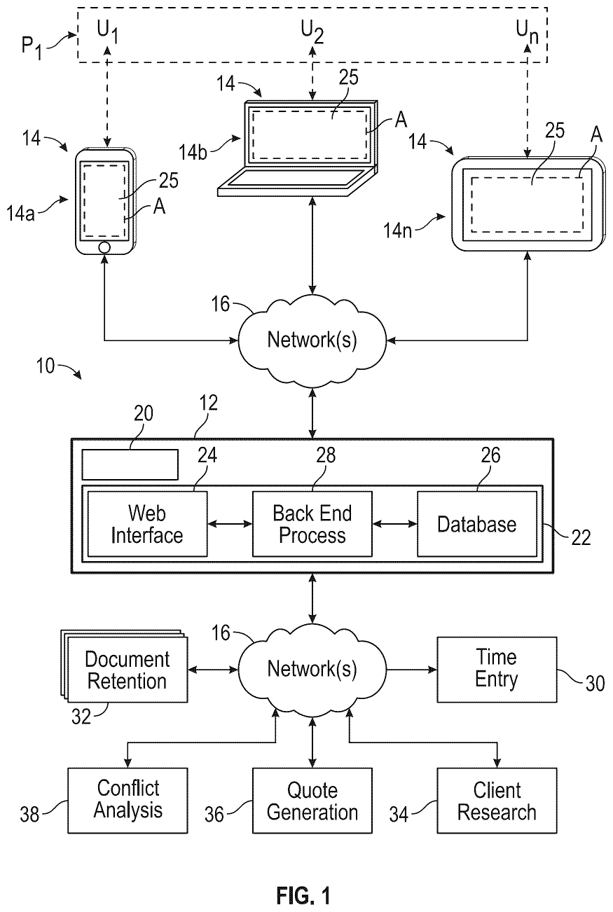

FIG. 1 illustrates an example embodiment of a system 10 for creating and implanting ethical screens in accordance with the present disclosure. In the illustrated embodiment, the system 10 includes a central server 12 and one or more user terminals 14 operated by one or more users U₁, U₂ . . . Uₙ of a first party P₁. The central server 12 is configured to wirelessly communicate with each of the user terminals 14 via a network 16 to implement the first party P₁'s ethical screens for one or more clients. As used herein, the first party P₁ is the party creating and implementing the ethical screen. The first party P₁ can be, for example, any business that accepts clients requiring ethical screens, for example, a consulting firm, a law firm, an accounting firm, or another business that services competitor clients. As used herein, the clients may also be referred to as second parties P₂.

Each of the plurality of user terminals 14 can be, for example, a cellular phone, a tablet, a personal computer, or another personal electronic device. Here, the plurality of user terminals 14 includes a first user terminal 14a, a second user terminal 14b, and an nth user terminal 14n. Each user terminal 14 can be controlled by a distinct user U₁, U₂ . . . Uₙ (e.g., a first user U₁ controls the first user terminal 14a, a second user U₂ controls the second user terminal 14b, and an nth user Uₙ controls the nth user terminal 14n). The user U₁, U₂ . . . Uₙ of each user terminal 14 can be, for example, a member or employee of the first party P₁. As used herein, each of the users U₁, U₂ . . . Uₙ can also be referred to generally as a user U. Using the system 10, any user U of the first party P₁ can create and implement one or more ethical screens regarding one or more second party P₂ using a respective user terminal 14.

The type of ethical screen may vary. In one embodiment, the ethical screen is a complete ethical screen that prevents any user U working on any matter for one second party P₂ (e.g., a first client) to be completely screened from information created or received from another second party P₂ (e.g., a second client). In another embodiment, the ethical screen may be a partial ethical screen that only screens for certain matters performed for a second party P₂. Although a single first party P₁ and two competitive second parties P₂ are discussed herein for simplicity, it should be understood from this disclosure that the system 10 can operate to support more complex ethical screens for any number of such parties P₁, P₂ and significantly decreases time spent implementing ethical screens, processing data related to such ethical screens, and memory storage to store data related to such ethical screens, particularly as the number of parties P₁, P₂ involved increases.

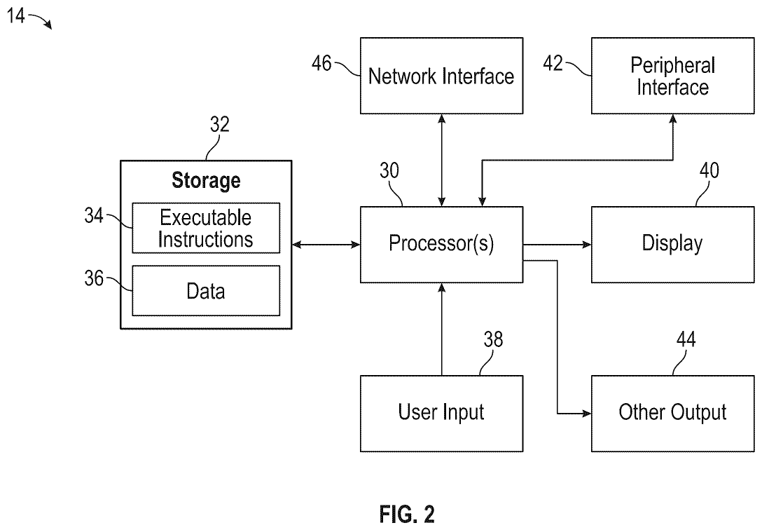

FIG. 2 illustrates a representative diagram of an example embodiment of a user terminal 14. As illustrated, a user terminal 14 can include a terminal processor 30 and a terminal memory 32. The terminal processor 30 is configured to execute instructions programmed into and/or stored by the terminal memory 32. The instructions can be received from and/or periodically updated by the web interface 24 of the central server 12 in accordance with the methods discussed herein. As described in more detail below, many of the functions described herein can be stored as instructions in the terminal memory 32 and executed by the terminal processor 30.

In an embodiment, the terminal processor 30 can comprise one or more of a microprocessor, microcontroller, digital signal processor, co-processor or the like or combinations thereof capable of executing stored instructions 34 and operating upon stored data 36, wherein the instructions 34 and/or stored data 36 are stored by the terminal memory 32. The terminal memory 32 can comprise one or more devices such as volatile or nonvolatile memory, for example, random access memory (RAM) or read only memory (ROM). Further, the terminal memory 32 can be embodied in a variety of forms, such as a hard drive, optical disc drive, floppy disc drive, etc. In an embodiment, many of the processing techniques described herein are implemented as a combination of executable instructions 34 and data 36 stored within the terminal memory 32.

As illustrated, each of the plurality of user terminals 14 includes one or more user input device 38, a display 40, a peripheral interface 42, one or more other output device 44, and a network interface 46 in communication with the terminal processor 30. The user input device 38 can include any mechanism for providing a user input to the terminal processor 30, for example, a keyboard, a mouse, a touch screen, a microphone and/or suitable voice recognition application, or another input mechanism. The display 40 can include any conventional display mechanism such as a cathode ray tube (CRT), a flat panel display, a touch screen, or another display mechanism. Thus, as can be understood, the user input device 38 and/or the display 40 and/or any other suitable element can be considered a GUI 25. The peripheral interface 42 can include the hardware, firmware, and/or other software necessary for communication with various peripheral devices, such as media drives (e.g., magnetic disk or optical disk drives), other processing devices, or another input source used as described herein. Likewise, the other output device 44 can optionally include similar media drive mechanisms, other processing devices or other output destinations capable of providing information to a user of the user terminal 14, such as speakers, LEDs, tactile outputs, etc. The network interface 46 can comprise hardware, firmware and/or software that allows the terminal processor 30 to communicate with other devices via wired or wireless networks 16, whether local or wide area, private or public. For example, such networks 16 can include the World Wide Web or Internet, or private enterprise networks, or the like.

While the user terminal 14 has been described as one form for implementing the techniques described herein, those having ordinary skill in the art will appreciate from this disclosure that other functionally equivalent techniques can be employed. For example, some or all of the functionality implemented via executable instructions can also be implemented using firmware and/or hardware devices such as application specific integrated circuits (ASICs), programmable logic arrays, state machines, etc. Further, other implementations of the user terminal 14 can include a greater or lesser numbers of components than those illustrated. Further still, although a single user terminal 14 is illustrated in FIG. 2, it should be understood from this disclosure that a combination of such devices can be configured to operate in conjunction (for example, using known networking techniques) to implement the methods described herein.

Referring again to FIG. 1, the central server 12 can comprise one or more server computers, database servers and/or other types of computing devices, particularly in connection with, for example, the implementation of websites and/or enterprise software. The central server 12 can further comprise a central processor 20 and a central memory 22. The central processor 20 is configured to execute instructions programmed into and/or stored by the central memory 22. In an embodiment, the central processor 20 can comprise one or more of a microprocessor, microcontroller, digital signal processor, co-processor or the like or combinations thereof capable of executing stored instructions and operating upon stored data, wherein the instructions and/or data are stored by the central memory 22. The central memory 22 can comprise one or more devices such as volatile or nonvolatile memory, for example, random access memory (RAM) or read only memory (ROM). Further, the central memory 22 can be embodied in a variety of forms, such as a hard drive, optical disc drive, floppy disc drive, etc. As described in more detail below, the steps of the methods described herein can be stored as instructions in the central memory 22 and executed by the central processor 20.

In the illustrated embodiment, the central memory 22 can include a web interface 24, a database 26, and back end processing instructions 28. Here, the web interface 24, the database 26, and the back end processing instructions 28 can be controlled or accessed by the central processor 20 implementing appropriate software programs by executing the back end processing instructions 28 or other instructions programmed into and/or stored by the central memory 22.

The web interface 24 can provide a graphical user interface (“GUI”) 25 that can be displayed on a terminal 14 for a user U, and can manage the transfer of data received from and sent to the GUI 25 on the terminal 14. For example, the GUI 25 can be employed by a user U to enter data about the second party P₂, to provide such data to the central server 12, and/or to receive or adjust adjusted GUI's that exclude information due to implemented ethical screens, as described in more detail below. In an embodiment, each user terminal 14 can include an application A comprising software downloaded to and executed by the terminal 14 to provide the GUI 25 and to manage communications with the central server 12. The application A can be downloaded to the user terminal 14 from the central server 12 or from some other source such as an application distribution platform.

The database 26 can store data relevant to the second party P₂, as well as data retrieved from the second party P₂ and data related to other software platforms such as a time entry platform 30, a document retention platform 32, a client research platform 34, a quote generation platform 36, a conflict analysis platform 38, or another software platform. In an embodiment, the database 26 can comprise a database management system (DBMS) operating on one or more suitable database server computers. Alternatively, the database 26 can comprise storage components from other systems, such as an existing client management tool having relevant data concerning the second party P₂ already stored therein. The database 26 can also include one or more application tables AT1, AT2 as discussed in more detail below.

The back end processing instructions 28 can be operatively coupled to both the web interface 24 and the database 26, and can be programmed into and/or stored by the central memory 22 and implemented by the central processor 20. In an embodiment, the back end processing instructions 28 can be executed by the central processor 20 to direct operations of the central server 12 as described below in further detail. For example, the central processor 20, executing the back end processing instructions 28, can manage the receipt, storage, maintenance, etc. of relevant data (e.g., received from one or more user U of the first party P₁ via a terminal 14) concerning second parties P₂. Additionally, the central processor 20, executing the back end processing instructions 28, can develop similar data relevant to the second party P₂ based on information obtained from the second party P₂, a third party, and/or an external software platform, as well as further functions discussed in more detail below.

In the illustrated embodiment, the system 10 is configured to implement an ethical screen in a plurality of different software platforms including at least two of a time entry platform 30, a document retention platform 32, a client research platform 34, a quote generation platform 36 and a conflict analysis platform 38. Those of ordinary skill in the art will recognize from this disclosure that other platforms can also be incorporated into the systems and methods described herein.

In the illustrated embodiment, the time entry platform 30 is a software platform that enables users U of the first party P₁ to create time entries (e.g., hourly, daily, etc.) that will be billed to a second party P₂. The time entries can be entered by a user U, for example, using a client number and/or a matter number. In addition to the client and/or matter number, the user U will typically also enter a date, an amount of time worked on the date, and a description of the work performed. An example embodiment of a time entry system 30 that can be ethically screened using the system 10 described herein is the time entry system described in U.S. patent application Ser. No. 17/718,019, entitled “Systems and Methods for Time Entry, Management and Billing,” assigned to Fulcrum Global Technologies Inc., which is incorporated by reference herein in its entirety.

In the illustrated embodiment, the document retention platform 32 is a software platform that enables users U of the first party P₁ to store work product created for a second party P₂. For example, the documents may include filings made for a second party P₂, research memorandums performed for a second party P₂, correspondence created for a second party P₂, or other work product created for or in the process of serving a second party P₂. In an embodiment, the documents can be saved using a client number and/or a matter number. In an embodiment, the documents can be saved using one or more company name. The documents can include, for example, documents stored in formats such a Microsoft Word, Excel, PowerPoint, etc.

In the illustrated embodiment, the client research platform 34 is a third-party software platform used to perform research for a company. The third-party research platform can include, for example, Westlaw or LexisNexis for legal research, Dunn and Bradstreet, Bureau Van Dijk, the Better Business Bureau or Transunion for business research, the Secretary of State or the Office of Foreign Assets Control (OFAC) for corporate, government, or sanctions research, or another third-party data research platform. In an embodiment, the research platform can be accessed via a public website. In an embodiment, a user U can log into the client research platform 34 and view a history of research performed by one or more user U for one or more second party P₂. In an embodiment, the research history is saved using an ID for the user U who performed the research. In another embodiment, the research history can be saved using a client number and/or a matter number.

In the illustrated embodiment, the quote generation platform 36 is a software platform that enables users U of the first party P₁ to generate a quote to bid (e.g., RFP) on work that the second party P₂ needs performed. The quote may include a summary of hours intended to be performed by a plurality of employees of the first party P₁. In an embodiment, each of the employees have an employee ID and/or are identified by name. An example embodiment of a quote generation platform 36 that can be ethically screened the system 10 described herein is the quote generation platform described in U.S. patent application Ser. No. 17/718,034, entitled “Systems and Methods for Generating Reliable Client Billing Quotes Based on a Team Including a Plurality of Members,” assigned to Fulcrum Global Technologies Inc., which is incorporated by reference herein in its entirety.

In the illustrated embodiment, the conflict analysis platform 38 is a software platform enabling a user U to run a conflict check on a potential new client. In an embodiment, the system 10 can use the conflict analysis platform 38 to automatically implement an ethical screen when a user U of a first party P₁ runs a conflict check that determines that a potential new client creates an ethical conflict with an existing client. In an embodiment, a user U can run a conflict check using the conflict management platform 38 by inputting the name of a second party P₂, which triggers the conflict analysis platform 38 to search existing clients and matters to make a conflict determination. An example embodiment of a conflict management platform 38 that can trigger an ethical screen using the system 10 described herein is the conflict management platform described in U.S. patent application Ser. No. 17/716,800, entitled “Systems and Methods for Client Intake and Management Using Hierarchical Conflict Analysis,” which is incorporated by reference herein in its entirety.

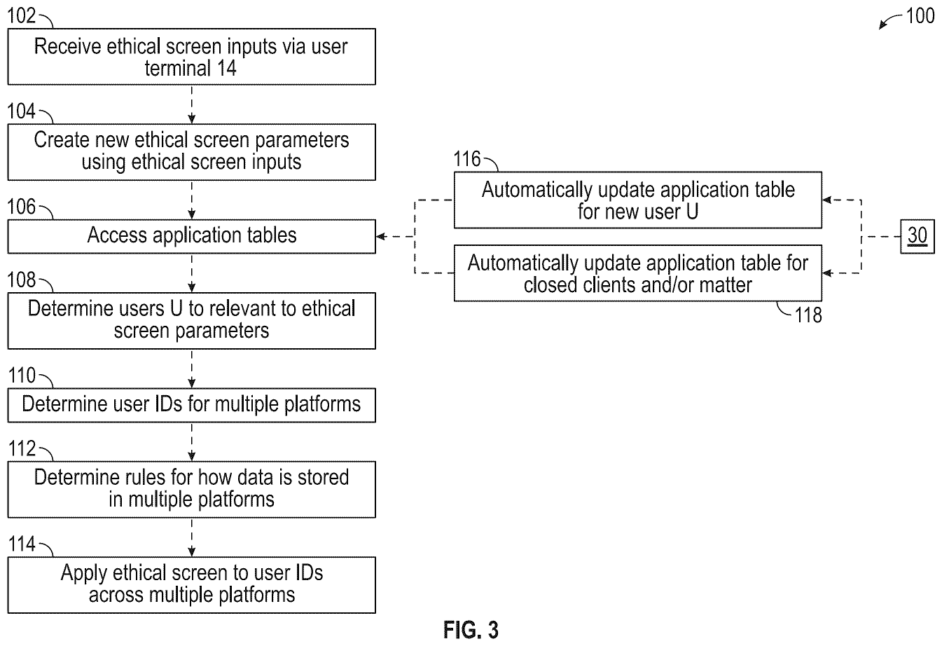

FIG. 3 illustrates an example embodiment of a method 100 for creating and implementing an ethical screen. The method 100 can be implemented by the system 10 described herein. In an embodiment, one or more of the steps of the method 100 can be stored as instructions on the central memory 22 and executed by the central processor 20. In an embodiment, one or more of the steps of the method 100 can be stored as instructions on the terminal memory 32 and executed by the terminal processor 30. It should be understood by those of ordinary skill in the art from this disclosure that some of the steps described herein can be reordered or omitted without departing from the spirit or scope of method 100.

At step 102, the system 10 receives ethical screen inputs. The ethical screen inputs can be automatically generated, can be input by a user U via a GUI 25 on a user terminal 14, or can be a combination of both.

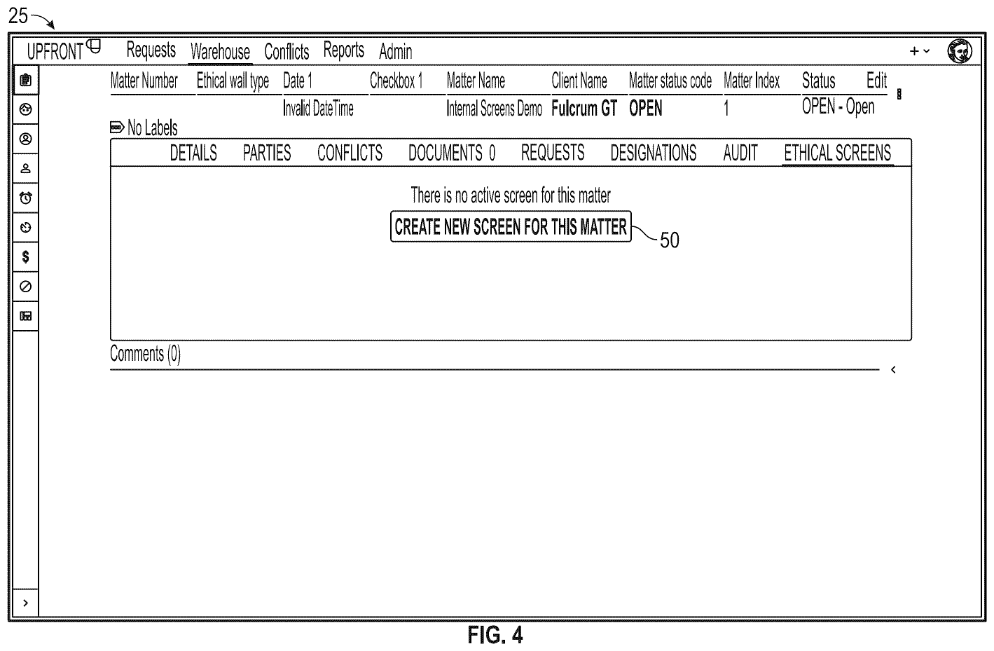

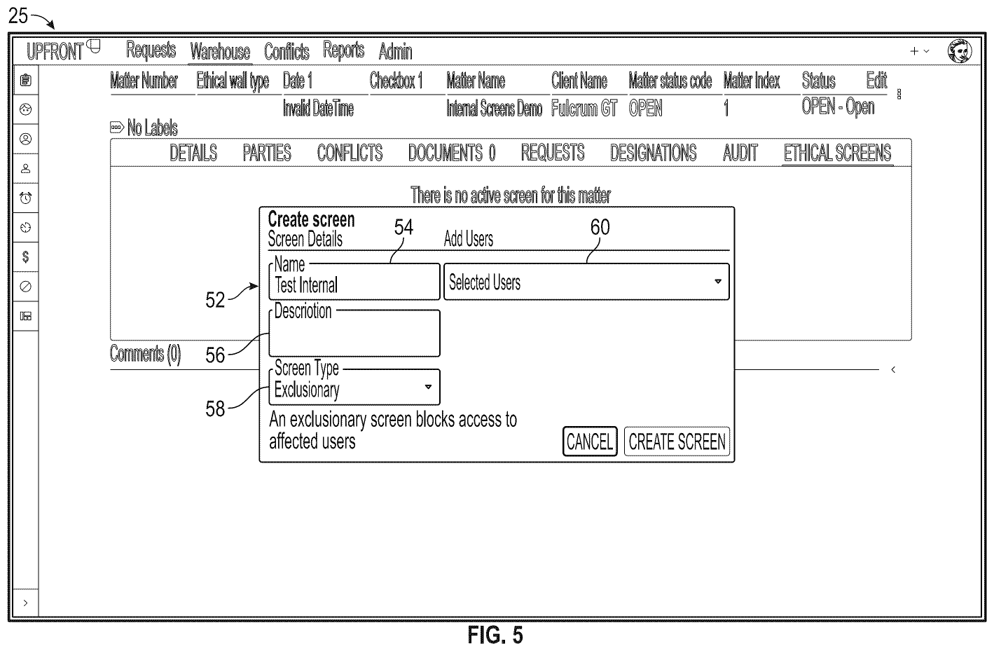

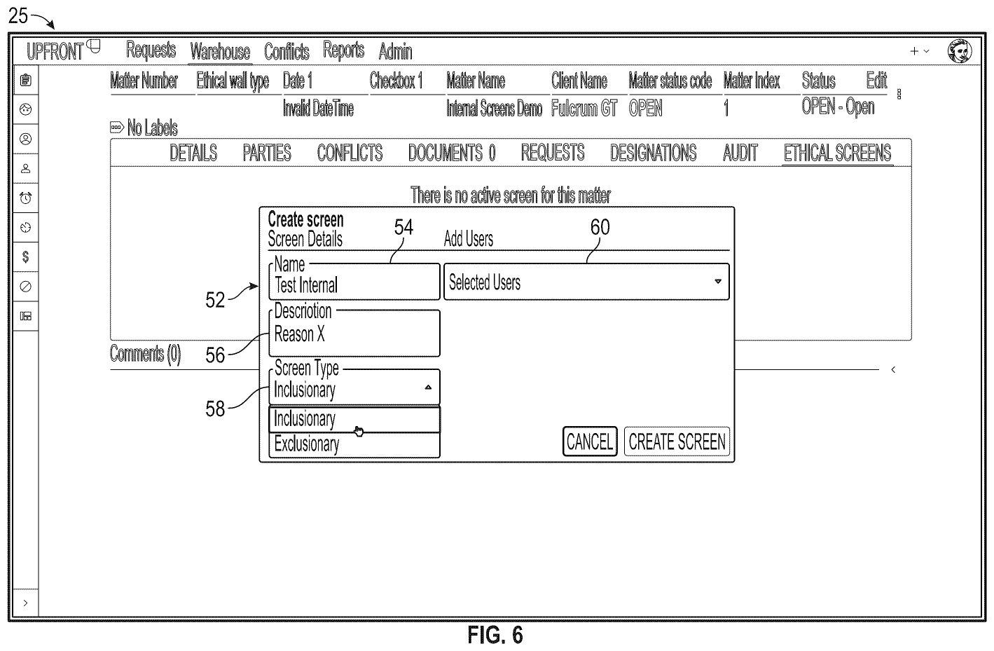

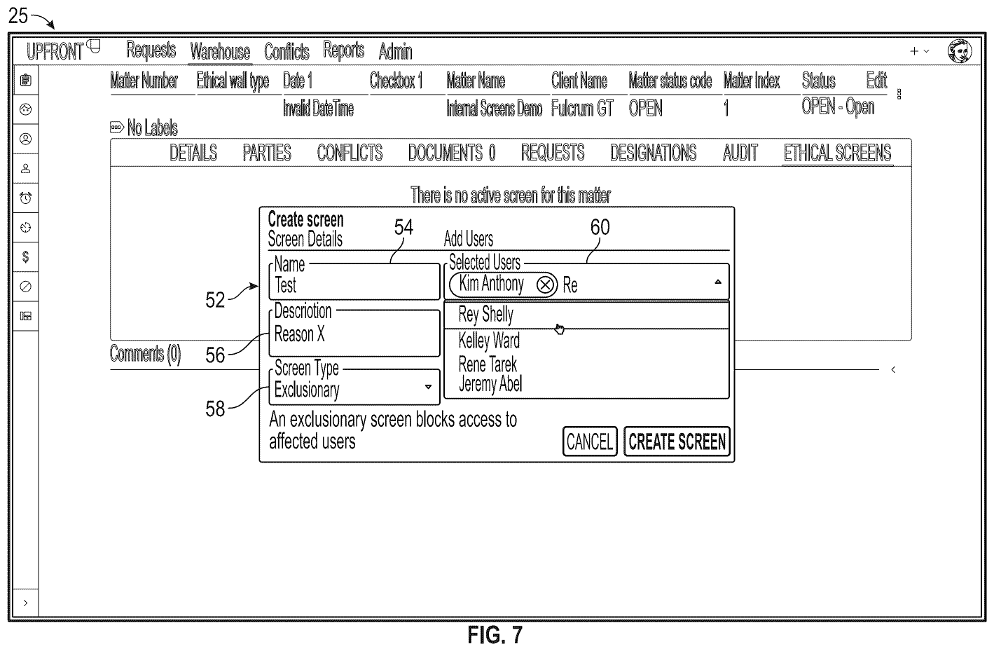

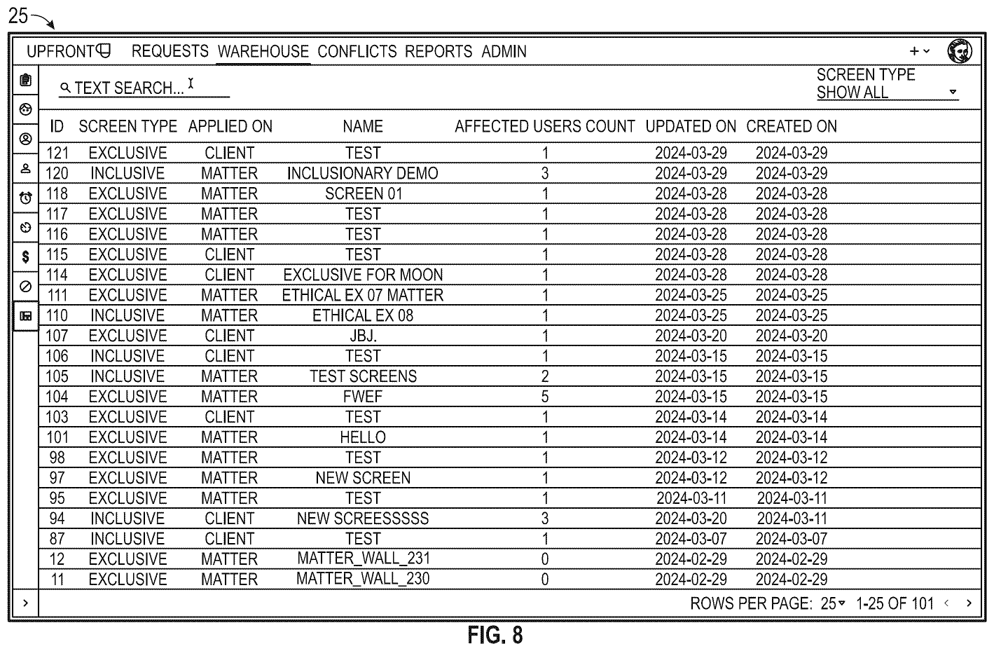

FIGS. 4 to 8 illustrate an example embodiment of a GUI 25 that enables a user U input information to implement the ethical screens in accordance with the present disclosure. FIG. 4 illustrates an initial screen on the GUI 25 enabling a user U to implement an ethical screen. In the illustrated embodiment, a user U creates a new ethical screen by selecting the new screen icon 50. FIGS. 5 to 7 illustrate a popup 52 on the GUI 25 that appears once the user U has selected the new screen icon 50 in FIG. 4. The popup 52 provides the user U with several prompts, including but not limited to a prompt 54 to enter an ethical screen name, a prompt 56 to enter an ethical screen description, and a prompt 58 to enter an ethical screen type. The user U is also provided a prompt 60 select other users U that will be subject to the ethical screen. As seen in FIGS. 6 and 7, the system 10 is configured to allow the user U to make an ethical screen either Exclusionary or Inclusionary. An Exclusionary Screen excludes other users U that are selected using the prompt 58, whereas an Inclusionary Screen excludes all users U besides the users U that are selected using the prompt 58. One advantage of the system 10 described herein is that the central server 12 can implement combinations of inclusionary and exclusionary screens across multiple software platforms. FIG. 8 illustrates an example embodiment with the GUI 25 providing a summary listing of all ethical screens currently in place by the first party P₁. As illustrated, some ethical screens are applied on the client level, whereas other ethical screens are applied on the matter level.

In another embodiment, the system is configured to automatically implement ethical screens based on a conflict analysis run by the conflict analysis platform 38. The conflict analysis platform 38 enables a user U to run a simple conflict analysis which analyses whether a conflict exists between a new client and an existing client. In an embodiment, the system 10 is configured to generate the ethical screen inputs based on that conflict analysis.

Referring again to FIG. 3, at step 104, the system 10 creates ethical screen parameters using the ethical screen inputs. In an embodiment, the ethical screen parameters are Exclusionary or Inclusionary with respect to particular users U. In another embodiment, the system 10 determines all of the users U who have performed work for a particular client and generates the ethical screen parameters as being exclusionary with respect to all users U that have performed work for that particular client. In another embodiment, the system 10 determines all of the users U who have performed work for one or more particular matters for a client and generates the ethical screen parameters as being exclusionary with respect to users U that have performed work for those particular matter(s). In another embodiment, the ethical screen parameters can include or exclude a combination of one or more of the particular users U, particular clients and/or particular matters.

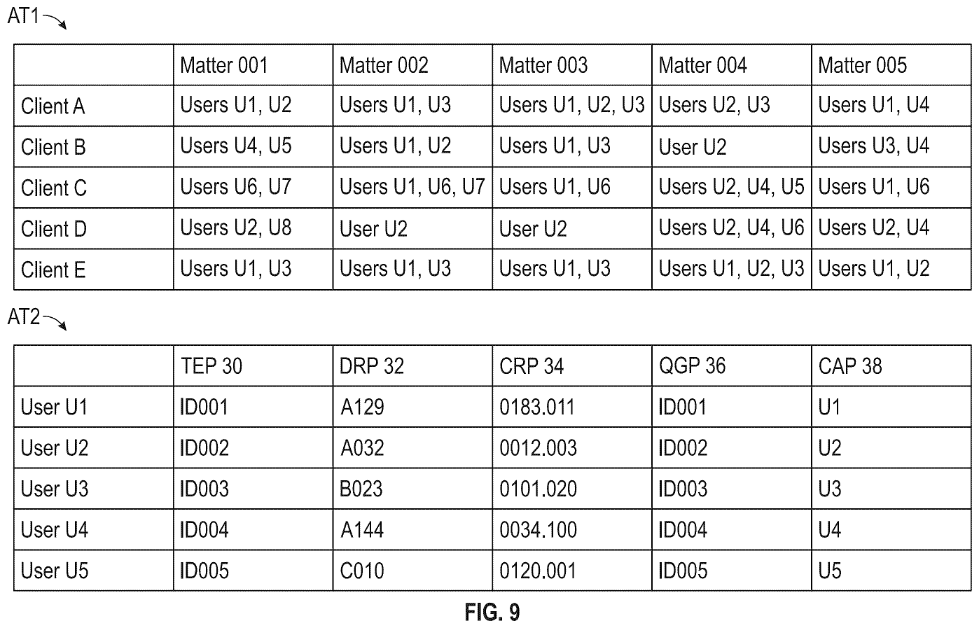

At step 106, the system 10 accesses one or more application tables stored in the database 26. FIG. 9 illustrates example embodiments of application tables AT1, AT2 that can be stored in the database 26. Application table AT1 cross-references clients and matters using the users U that have worked on those matters. In an embodiment, the application table AT1 can further include alternative client names, names of adverse parties to the current or former clients, and names of affiliates of clients or adverse parties. Application table AT2 references users U with the various platforms using user identifications (IDs) and/or passwords used on those platforms. In application table RT2, TEP 30 is the time entry platform 30, DRP 32 is the document retention platform 32, CRP 34 is the client research platform 34, QGP 36 is the quote generation platform 36, and CAP 38 is the conflict analysis platform 38. Those of ordinary skill in the art will recognize from this disclosure that other types of application tables can also be used.

At step 108, the system 10 uses the generated ethical screen parameters to determine which users U to screen across multiple platforms. For example, the system 10 can use the application table AT1 to determine which users U to screen across multiple platforms based on the clients and/or matters which have been worked on by the users U. In an embodiment, the ethical screen parameters identify an existing client that is a competitor of a new client, necessitating that all users U who have worked on the existing client be screened from working on the new client. In this case, the system 10 is configured to access the application table AT1 to determine all of the users U who have worked on the existing client. In another embodiment, the ethical screen parameters identify particular matters for an existing client that is a competitor of a new client, necessitating that all users U who have worked on those matters be screened from working on the new client. In this case, the system 10 is configured to access the application table AT1 to determine all of the users U who have worked on those matters. In another embodiment, the ethical screen parameters from step 104 identify specific users U.

At step 110, the system 10 determines a plurality of user IDs and/or passwords for the users U identified at step 108. For example, the system 10 can cross-reference the application table AT1 with the application table AT2 to determine plurality of user IDs and/or passwords for the users U identified at step 108. In some cases, users U may use the same user ID and/or password for multiple platforms. The user IDs and/or passwords stored in the application table AT2 may be different from the user ID and/or password that a user U actually uses to log into a platform. In an embodiment, the application table AT2 identifies at least two different user IDs and/or passwords for at least two different software platforms.

At step 112, the system 10 determines the rules for how data is individually stored in each of the various platforms 30, 32, 34, 36, 38 identified with respect to a user ID and/or password. The system 10 then accesses each platform 30, 32, 34, 36, 38 and uses the respective user ID and/or password determined at step 110 to restrict that user U from accessing data related to the new client on that platform 30, 32, 34, 36, 38. For example, the system 10 can cause the time entry platform 30 to prevent the user U from entering time with respect to the new client and/or viewing time entered by others for the new client. The system 10 can cause the document retention platform 32 to prevent the user U from accessing documents prepared for the existing client. The system 10 can cause the client research platform 34 to prevent the user U from accessing research histories related to research performed for the existing client. The system 10 can cause the quote generation platform 36 to prevent a quote from being generated for the existing client using someone who has worked for the new client, and vice versa.

At step 114, the system accesses each of the multiple platforms and uses the user IDs and/or passwords and rules to place restrictions on the users U. In an embodiment, the system 10 implements the ethical screens in one or both of two ways. In one embodiment, the central server 12 sends ethical screen-related data via application programming interfaces (APIs) to one or more of the downstream platform 30, 32, 34, 36, 38. In another embodiment, one or more of the downstream platforms 30, 32, 34, 36, 38 use one or more APIs to pull the ethical screen data from the central server 12.

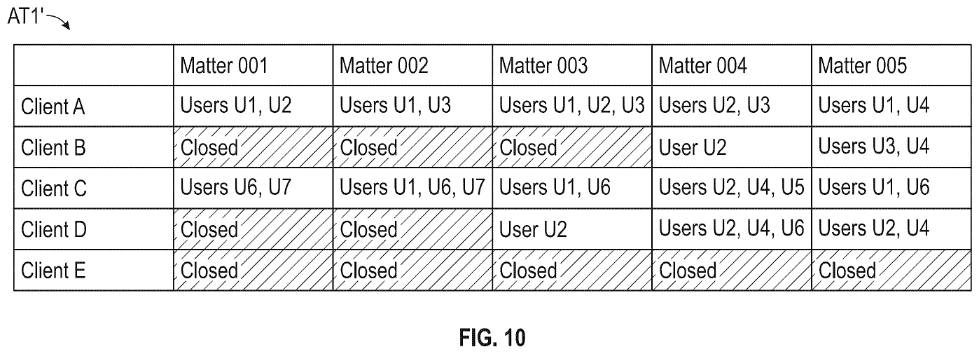

The system 10 is configured to constantly update the application tables AT1, AT2. For example, as seen in FIG. 3 at step 116, the system 10 updates the application table AT1 based on time entries made in the time entry platform 30. In an embodiment, the time entry system 30 keeps track of the users U that have billed time entries to a particular client and/or matter, and when a user U who has not previously worked for a client and/or matter enters time related to that client or matter, the system 10 updates the application table RT1 to include that user U cross-reference for the client and/or matter. In another example, at step 118, when a client and/or matter is closed in the time entry platform 30, the system 10 updates the application table AT1 to delete or ignore that client and/or matter. An example of this embodiment is illustrated by the application table AT1′ shown in FIG. 10. In this case, the users U that worked on that client and/or matter may not need to be screened going forward, and/or a current ethical screen may be removed by the system 10 depending on the circumstances.

The systems and methods described herein are advantageous for creating and implementing ethical screens across different software and hardware systems. It should be understood that various changes and modifications to the methods described herein will be apparent to those skilled in the art and can be made without diminishing the intended advantages.

### GENERAL INTERPRETATION OF TERMS

In understanding the scope of the present invention, the term “comprising” and its derivatives, as used herein, are intended to be open ended terms that specify the presence of the stated features, elements, components, groups, and/or steps, but do not exclude the presence of other unstated features, elements, components, groups, integers and/or steps. The foregoing also applies to words having similar meanings such as the terms, “including”, “having” and their derivatives. Also, the terms “part,” “section,” or “element” when used in the singular can have the dual meaning of a single part or a plurality of parts. Accordingly, these terms, as utilized to describe the present invention should be interpreted relative to a connecting device.

The term “configured” as used herein to describe a component, section or part of a device includes hardware and/or software that is constructed and/or programmed to carry out the desired function.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A method for implementing an ethical screen across a plurality of different software platforms, the method comprising:
receiving ethical screen inputs regarding a conflict between a first client and a second client;
generating ethical screen parameters based on the ethical screen inputs;
accessing at least one application table to determine a plurality of users corresponding to the ethical screen parameters; and
implementing the ethical screen across the plurality of different software platforms using a plurality of user identifications or passwords corresponding to the plurality of users.

2. The method of claim 1, wherein
the plurality of different software platforms includes at least two of a time entry platform, a document retention platform, a client research platform, a quote generation platform, and a conflict analysis platform.

3. The method of claim 1, wherein
accessing the at least one application table includes accessing a first application table cross referencing a plurality of clients with the plurality of users and accessing a second application table cross referencing the plurality of users with the plurality of user identifications or passwords corresponding to the plurality of different platforms.

4. The method of claim 1, wherein
accessing the at least one application table includes determining the plurality of user identifications or passwords from the application table.

5. The method of claim 1, comprising
automatically updating the at least one application table when a new user creates a time entry for one of the first client and the second client.

6. The method of claim 1, comprising
automatically updating the at least one application table when at least one of a client or a matter is closed.

7. A method for implementing an ethical screen across a plurality of different software platforms, the method comprising:
receiving ethical screen inputs regarding a conflict between a first client and a second client;
generating ethical screen parameters applied to a plurality of matters for the first client;
accessing an application table to determine a plurality of users corresponding to the plurality of matters; and
applying the ethical screen across the plurality of different software platforms using a plurality of user identifications or passwords corresponding to the plurality of users as defined by the application table.

8. The method of claim 7, wherein
applying the ethical screen across the plurality of different software platforms includes sending ethical screen data via application programming interfaces to at least one of the plurality of different software platforms.

9. The method of claim 7, wherein
applying the ethical screen across the plurality of different software platforms includes enabling at least one of the plurality of different software platforms to use one or more application programming interfaces to periodically pull ethical screen data from a central server.

10. The method of claim 7, wherein
accessing the application table includes accessing a first application table cross referencing a plurality of clients with the plurality of users and accessing a second application table cross referencing the plurality of users with the plurality of user identifications or passwords corresponding to the plurality of different software platforms.

11. The method of claim 7, comprising
automatically updating the at least one application table when a new user creates a time entry for one of the first client and the second client.

12. The method of claim 7, comprising
automatically updating the at least one application table when at least one of a client or a matter is closed.

13. The method of claim 7, wherein
the plurality of different software platforms includes at least two of a time entry platform, a document retention platform, a client research platform, a quote generation platform, and a conflict analysis platform.

14. A system for implementing an ethical screen across a plurality of different software platforms, the system comprising:
a first software platform utilized by a first user and a second user of a first party to perform a first task for a plurality of clients;
a second software platform utilized by the first user and the second user of the first party to perform a second task for the plurality of clients;
at least one application table corresponding ethical screen parameters to the first user and the second user of the first party; and
a central server including a processor and a memory, the processor configured to implement instructions stored on the memory to (i) generate an ethical screen that prohibits the first user from working for a second client of the plurality of clients and prevents the second user from working for a first client of the plurality of clients, (ii) use the at least one application table to encode the first software platform and the second software platform to implement a first screen preventing the first user from accessing work performed for the second client, and (iii) use the at least one application table to encode the first software platform and the second software platform to implement a second screen preventing the second user from accessing work performed for the first client.

15. The system of claim 14, wherein
the first platform includes one of a time entry platform, a document retention platform, a client research platform, a quote generation platform, and a conflict analysis platform, and
the second platform includes another of the time entry platform, the document retention platform, the client research platform, the quote generation platform, and the conflict analysis platform.

16. The system of claim 14, wherein
the at least one application table includes (i) a first application table cross referencing the plurality of clients with a plurality of users including the first user and the second user, and (ii) a second application table cross referencing the plurality of users including the first user and the second user with a plurality of user identifications or passwords corresponding to a plurality of different software platforms including the first software platform and the second software platform.

17. The system of claim 14, wherein
one of the plurality of different software platforms includes a time entry platform, and
the central server is configured to update the at least one application table when the first user or the second user creates a time entry for one of the plurality of clients using the time entry platform.

18. The system of claim 14, wherein
one of the plurality of different software platforms includes a time entry platform, and
the central server is configured to update the at least one application table when at least one of a client or a matter is closed in the time entry platform.

19. The system of claim 14, wherein
one of the plurality of different software platforms includes a conflict analysis platform, and
the central server is configured to update the at least one application table when the conflict analysis platform determines a conflict for a new client with respect to an existing client.

20. The system of claim 14, wherein
the first screen is an exclusionary screen implemented against the first user, and
the second screen is an inclusionary screen implemented against users besides the second user.
